(19) United States
(12) Patent Application Publication
(10) Pub. No.: US 2007/0277619 A1
(43) Pub. Date: Dec. 6, 2007

(54) Method for measuring deformations in test specimens and a system for marking the test specimens

(76) Inventors: Randy-David Burce Grishaber, Asbury, NJ (US); Matthew Krever, Warren, NJ (US); Daniel Olsen, Califon, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/410,180

(22) Filed: Apr. 24, 2006

Related U.S. Application Data
(60) Provisional application No. 60/676,848, filed on May 2, 2005.

(51) Int. Cl. G01B 11/16; B23K 26/00

(52) U.S. Cl. 73/762; 219/121.82

(57) ABSTRACT

A process and device for marking and measuring test specimens in order to determine the deformation properties of the test specimen utilizing an energy based system for creating high resolution gauge marks.

### CROSS REFERENCE TO RELATED APPLICATIONS

This application claims the benefit of U.S. Provisional Application 60/676,848, filed on May 2, 2005, which is incorporated by reference herein in its entirety.

### BACKGROUND OF THE INVENTION

1. Field of the Invention

The present invention relates to a process and device for improving measurement capabilities, and more particularly to a process and device for marking and measuring test specimens in order to determine the deformation properties of the test specimen, including the measurement of macro and micro deformations in the test specimens.

2. Discussion of Related Art

Currently utilized deformation measurement techniques, as illustrated in FIG. 1, utilize an airbrush and stencil marking system in order to create a series of spaced reference marks of known separation on the specimen to be tested. The distance between these marks is referred to as the gauge length and each mark is referred to as a gauge mark.

Prior methods for marking test specimens, such as sheets, bars and tubes for deformation testing such as tensile testing and elongation testing measurement have a number of drawbacks. For example, certain marking techniques, such as chemical etching and mechanical scratching, may actually alter the surface of the sample to the point where premature failures are induced, thus the test preparation negatively impacts test results. In addition, common marking techniques used to avoid surface damage, such as spray painting, produce marks which may have poorly defined edges, which may reduce the repeatability and precision of measurements, and due to this the minimum spacing of the marks is limited. In addition, these types of marks may be difficult to visualize because of a lack of contrast.

### SUMMARY OF THE INVENTION

The present invention overcomes the difficulties associated with currently utilized processes and devices as briefly described above.

In accordance with a first aspect, the present invention is directed to a method for measuring deformations in test specimens. The method comprises marking at least one test specimen with one or more high resolution gauge marks, deforming the at least one test specimen, and measuring a positional change between the one or more high resolution gauge marks.

In accordance with another aspect, the present invention is directed to a system for marking test specimens. The system comprises an indexing fixture configured to hold and position one or more test specimens, and an energy source, positioned proximate the indexing fixture, for producing high resolution markings on the one or more test specimens.

In accordance with another aspect, the present invention is directed to a test specimen comprising at least one high resolution gauge mark.

The present invention utilizes an energy based device such as a laser to create fine lines, or other fiducial delineations or gauge marks for measurement taking. Due to the precise control available from the laser marking system of the present invention, the energy delivered to the specimen surface may be controlled to the degree that premature failures at the marking points are significantly reduced or eliminated. The presently described system accomplishes this through the production of marks which impact the sample's surface to no more than one half the grain size of the test specimen, for polycrystalline materials. The laser marks are extremely well defined with precise edges and narrow total width, for example, less than one thousandth of an inch so that they may be more precisely measured for post-test gauge lengths and spaced more tightly. With the appropriate laser, total widths of less than ten microns may be achieved.

The present invention is directed to a novel method for improving the determination of elongation (i.e., strain carrying) capability of tubular or other shaped test specimens. In order to determine elongation of a material being tensile tested, a change in gauge length from the pre-tensile tested to the post-tensile tested state needs to be measured. Strain is defined as the change in length of the specimen divided by the original length of the specimen. This relationship may be formulaically represented as
E=dL/Lo,
where E is strain, dL is change in length, and Lo is original specimen length.

The present invention discloses a method for marking test samples via a laser marking device which produces extremely fine, well-defined marks which facilitate more accurate gauge length measurement and tighter/smaller spacing of the gauge marks.

In accordance with the present invention the test specimen, for example, a tube is placed under the laser marking system (a commercially available galvo device such as the Rofin EasyMark) on a fixture long enough to support the entire length of the sample. A one axis, servo or stepper motor controlled platform moves the tube underneath the laser head in a direction aligned with the tube sample's primary axis (the indexing direction). The index distance is based on the desired gauge length. The laser can image in two axes that allows it to place the marks transverse to the axis of the tube and indexing motion that produces a gauge length mark of suitable quality for measurement and appropriate spacing.

### BRIEF DESCRIPTION OF THE DRAWINGS

The foregoing and other aspects of the present invention will best be appreciated with reference to the detailed description of the invention in conjunction with the accompanying drawings, wherein:

FIG. 1 is a diagrammatic representation of a prior art system for marking test specimens.

FIG. 2 is a graphical illustration of strain capability versus gauge length in accordance with the present invention.

FIG. 3 is a diagrammatic representation of a system for marking in accordance with the present invention.

FIG. 4a is a diagrammatic representation of a first exemplary indexing device in accordance with the present invention.

FIG. 4b is a diagrammatic representation of a second exemplary indexing device in accordance with the present invention.

FIG. 5a is an image of a tubular specimen with airbrush gauge marks prior to testing.

FIG. 5b is an image of the tubular specimen of FIG. 5a after testing.

FIG. 5c is an image of a tubular specimen with gauge marks made in accordance with the present invention prior to testing.

FIG. 5d is an image of the tubular specimen of FIG. 5c after testing.

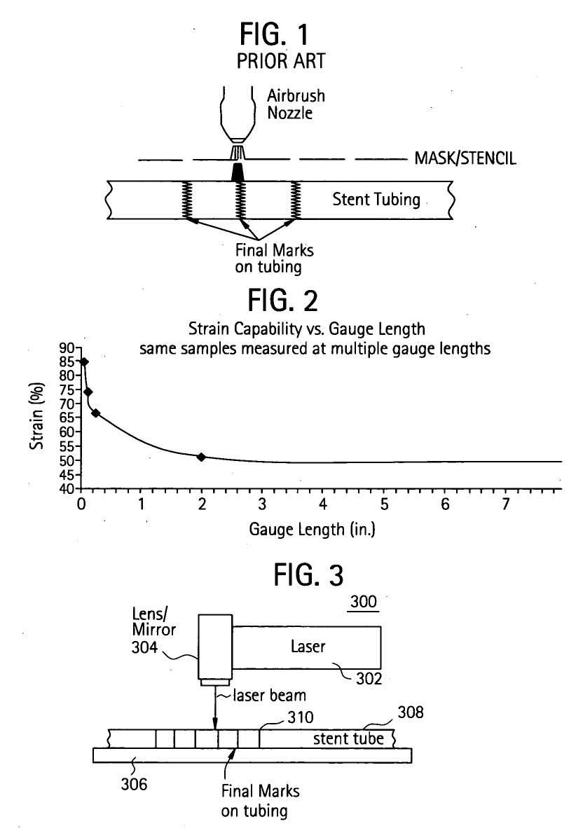

### DETAILED DESCRIPTION OF THE PREFERRED EMBODIMENTS

The present invention is directed to a methodology and system for accurately marking specimens to be tested. The methodology and system may utilize any number of marking techniques, any number of energy based marking devices capable of producing high resolution gauge marks and any number of measuring devices on a multitude of test specimens of varying size, shape, and composition. For ease of explanation, however, an exemplary embodiment is described with respect to a metallic tubular structure suitable for the manufacture of intravascular devices such as stents. In addition, although any type of marking device may be utilized, the exemplary embodiment is described with a laser as the marking device.

The present invention utilizes an energy based device such as a laser to create fine line delineations or gauge marks for measurement taking. Due to the precise control available from the laser marking system, the energy delivered to the specimen surface may be controlled to the degree that premature failures at the marking points are significantly reduced or eliminated. The laser marks are extremely well-defined with precise edges and narrow total width, for example, less than one thousandth of an inch so that they may be more precisely measured for post-test gauge lengths and spaced more tightly. With the appropriate laser, widths of less than ten microns may be achieved.

High resolution marking and spacing is what truly makes this improved measurement method valuable. For small diameter, thin walled tubes, a significant portion of the plastic deformation that occurs during tensile testing happens over a very short (as measured in the tube-axial direction) distance (<0.125″). If gauge marks are placed too far apart, the change in length of the specimen due to this necking elongation is not captured during typical elongation measurement. Instead what is measured is the bulk elongation of the material. Since most devices made from thin walled metal tube contain dimensions well under this length scale (typically in the 0.002″-0.010″ size range), accurately capturing the maximum elongation possible from the material at this scale is critical for proper characterization of the material and device.

For plastically deformable devices like stents, higher elongation capability is desirable, since it allows for more expansion of a device to accommodate clinicians needs without device failure. If the elongation capability of the material at this length scale is not known during device design, overly conservative assumptions based on the bulk elongation properties of the material must be used in device design and analysis, which leads to lower performing designs (e.g. lesser stent crimping and overexpansion capability).

It has been shown through experimentation (at 8″, 2″, and ¼″ gauge lengths) and extrapolation that as the gauge length spacing becomes smaller (and better scaled to capture the necking elongation of the test sample), that the actual measured elongation will increase. FIG. 2 illustrates a plot of elongation increase trend. One can see that as gauge length gets smaller the increase in elongation measured can be dramatic as more of the necking strain is captured. Thus, the value of the present invention, becomes clear. The present invention allows for both lower measurement noise/error (due to finer more controlled marks), and more tightly spaced gauge marks, which allows for smaller gauge lengths.

Therefore, the present invention enables the direct quantification and documentation of higher elongation capabilities for material configurations than has previously been possible. This allows for higher performing stent designs (or other plastically deformable devices) to be created.

In addition, by use of the precision laser illumination source, a thermodynamically stable oxide may be grown from the native surface when the marking is conducted within an oxidative environment. Intrinsic to the nature of thin ceramic films that are grown from the base material, the resultant oxide film will be strongly adherent to the interfacial (i.e. material to oxide) basal plane. As the surface evolves under applied long-range stress (e.g. that induced under a uniaxial state by the tensile tester), the marked surface grains (i.e. discrete monocrystallographic structures that combine to form the overall polycrystalline tube) slide, rotate and/or deform to provide a form of structural stress relief. The present invention provides for a tenaciously adherent surface marking to be attached to each of these discrete surface grains thereby providing for accurate determination of surface grains both on a macro (or long-range) basis to track overall and modestly localized strains between the principal gage marks. In addition, the individualized marking of each discrete grain provides for the opportunity to track localized surface strains on the granular level so as to provide a meso to micro perspective when evaluating imparted deformation to the tube and/or specimen under test.

In accordance with the present invention, the test specimens may be coated with any number of suitable coating materials that serve a number of functions. For example, the test specimens to be measured may be coated with a material that creates an optimal ablation environment so that the energy from the energy source (laser) does not heat the base material comprising the test specimen while creating or cutting the gauge marks or delineations. In other words, by judicious selection of a coating material and/or control over the energy source (frequency, amplitude, power) gauge marks or other delineations may be made in the coating material which absorbs the energy from the energy source with minimal transmission to the underlying base material comprising the test specimen, thereby shielding the base material from any deleterious effects that may be produced by the energy source. One such coating material or layer is the oxide layer described above.

In addition to utilizing any suitable coating, any suitable coating technique may be utilized to apply the coating material to the base test specimen. For example, depending upon the base material, the coating material and the derived thickness of the coating, the coating material may be applied utilizing any number of well known techniques including airbrush spray painting, anodizing and/or dip coating. The depth or thickness of the coating is an important factor as is explained in detail subsequently. Regardless of the coating material and the coating application process, it is important that the coating be a conformal coating that moves with the base material comprising the test specimen on both the macro and microscopic scale such that as the base material is manipulated or deformed, the coating deforms in a manner as precisely as the underlying base material. For example, if the test specimen is stretched a predetermined distance, then the coating should stretch the same predetermined distance so that the measurements are accurate. Typical conformal coatings include Parylene, silicone, acrylic, urethane and epoxy.

In a slight variation, the energy source may be utilized to bond the coating material to the surface of the base material comprising the test specimen at the points of demarcation or delineation while the portions not exposed to the energy source may be removed utilizing a particular solvent. In this particular variation, raised guage marks or delineations are formed utilizing energy based bonding. This variation results in an embossed surface. This particular variation is similar to the creation of semiconductor mask works utilizing photoresist and is well known in the semiconductor fabrication art.

In addition to the coating being conformal, it is preferable that the coating material be a material that is in stark contrast to the underlying base material comprising the test specimen, or at least becomes a color or texture that is in stark contrast to the base material when exposed to the energy source. A stark contrast will make it easier to read and/or measure the delineations.

If no coating is utilized, the energy source may be utilized in the production of gauge marks which impact the test specimen's surface to no more than one half the grain size of the test specimen for polycrystalline materials. If a laser is utilized as the energy source, the laser marks are extremely well defined with precise edges and narrow total widths, for example, less than one thousandth of an inch so that they may be more precisely measured for post-test gauge length and spaced more tightly. Obviously, the closer the spacing, the more precise the measurement. With the appropriate laser and optics, total widths of less than ten microns may be achieved. In other words, ultra high resolution gauge marks may be formed with a width of no lesser than the frequency of the energy source to create the gauge marks or delineations, which may be less than ten microns, for example, on the order of about two microns. The higher the resolution of the energy source, the higher degree of control over the size and shapes of the marks. It is important to note that this applies to coated as well as non-coated surfaces; however; non-coated or uncoated surfaces are subject to potential deleterious effects as described herein.

While the width and spacing of the gauge marks or delineations are important, the depth of the gauge marks or delineations are also important. The less invasive the gauge mark, the less likely is the gauge mark to change the characteristics of the underlying base material and thus lessen its impact on the test results. Accordingly, while controlling the depth as described herein is important, the use of coatings as described above may lessen the impact of potential base material surface modifications. In other words, the use of coatings may result in substantially no possibility of altering the characteristics of the underlying base material. For example, in one exemplary embodiment, the energy source may be set to cut or ablate to a depth equal to that of the coating material such that the underlying test specimen surface is exposed but not touched. Alternately, the energy source may be set to cut or ablate to a depth only partially through the coating material, thereby, creating a mark or delineation in the coating material only. In yet another alternate embodiment, the energy source may be set to cut or ablate through the coating material and just into the surface of the underlying test specimen. While the surface of the test specimen is marked, it is to a much less extent than what would be required in a non-coated test specimen. As is seen, the depth of a coated or uncoated test specimen may be varied to suit a particular need. The depth of cut depends on a number of factors, including the underlying material, the coating material and the energy source.

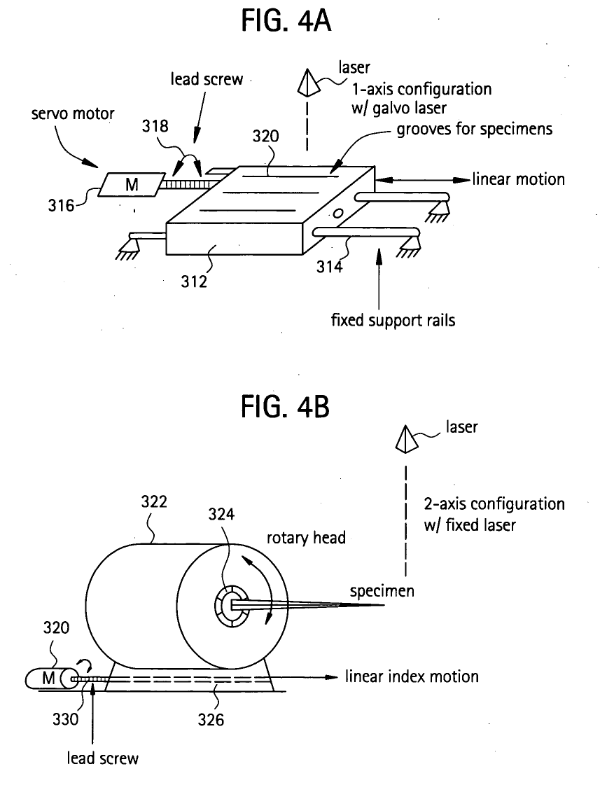

Referring to FIG. 3, there is illustrated an exemplary system 300 in accordance with the present invention. The system 300 comprises an energy based marking device 302, such as a laser, an energy directing/focusing apparatus 304, such as a lens and mirror arrangement, and an indexing device 306, such as a servo motor driven linear stage fitted with grooves and clamps to hold test specimens. Also illustrated is a specimen 308 with gauge marks 310 produced by the laser 302. FIGS. 4a and 4b are detailed illustrations of two types of indexing devices 306. In a first exemplary embodiment, illustrated in FIG. 4a, the indexing device 306 comprises a moveable stage 312, fixed support rails 314 upon which the stage 312 moves, and a motor 316 connected to the stage 312 by a lead screw 318. The stage 312 comprises one or more grooves 320 to hold the test specimens. FIG. 4b illustrates an alternate exemplary embodiment and is described in detail subsequently.

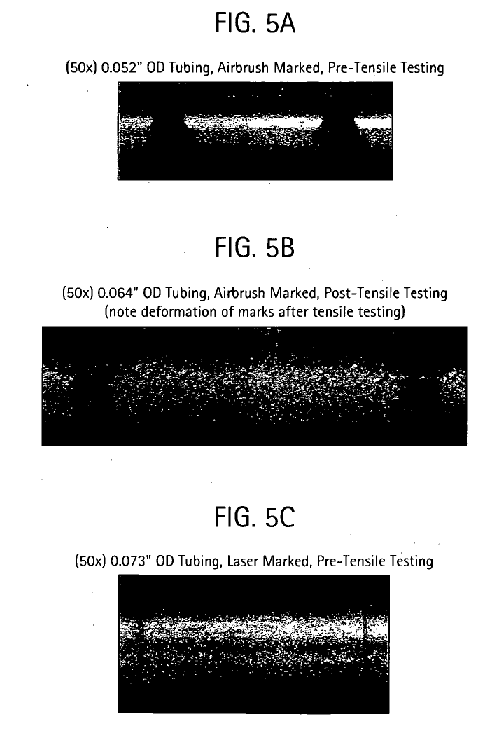

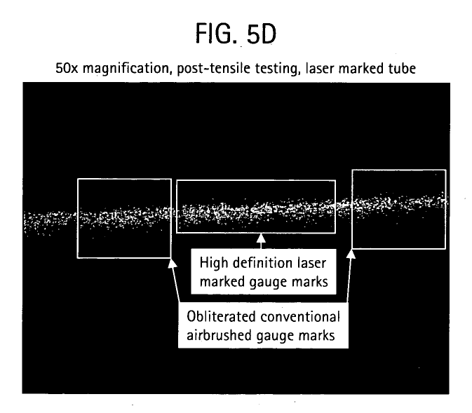

FIGS. 5a and 5b illustrate tubular specimens marked with airbrush techniques. FIG. 5a is the specimen pre-tensile testing and FIG. 5b is post-tensile testing. As can be seen there is a substantial difference between the gauge marks. FIGS. 5c and 5d illustrate tubular specimens marked with the present invention. As can be seen, the gauge marks are cleaner and finer both pre and post testing.

To facilitate measurement of extremely small gauge length marks (which is possible with present invention), SEM microscopy could be used for specimen measurement in addition to traditional light microscopy or magnification techniques.

This method could be used to improve the tensile testing of non-tubular geometry samples such as wire or bar.

This method could be used to improve the tensile testing of non-metallic samples such as polymers or ceramics.

This method could be used to improve the deformation testing of complex multi-axial deformation tested samples such as stamped sheet metal.

FIG. 4b illustrates an alternate exemplary embodiment of an indexing device 306. In this exemplary embodiment, the device 306 comprises a rotary head 322, a clamping mechanism 324 positioned within the rotary head 322 to hold the specimen, a linear stage 326 and a motor 328 connected to the linear stage 321 via a lead screw 330. The rotary head 322 includes a motor, not illustrated. In this exemplary embodiment, the specimen under test may be moved linearly and/or rotationally. In other words, the energy based marking system could also be comprised of a fixed position energy based marking device with a positioning fixture that has at least two axes of motion: a rotary motion and a linear motion. This would allow for the creation of complex gauge mark shapes on the test specimens. For example, a single spiral line may be created rather than a series of lines.

Although shown and described is what is believed to be the most practical and preferred embodiments, it is apparent that departures from specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

What is claimed is:

1. A method for measuring deformations in test specimens comprising:
marking at least one test specimen with one or more high resolution gauge marks;
deforming the at least one test specimen; and
measuring a positional change between the one or more high resolution gauge marks.

2. A system for marking test specimens comprising:
an indexing fixture configured to hold and position one or more test specimens; and
an energy source, positioned proximate the indexing fixture, for producing high resolution markings on the one or more test specimens.

3. A test specimen comprising at least one high resolution gauge mark.

4. A method for measuring deformations in test specimens comprising:
marking at least one test specimen with one or more gauge marks utilizing electromagnetic energy, the gauge marks having a width greater than or equal to a frequency of the electromagnetic energy;
deforming the at least one test specimen; and
measuring a positional change between the one or more gauge marks.

5. A method for measuring deformations in test specimens comprising:
coating at least one test specimen with a coating material;
marking the at least one test specimen with one or more gauge marks utilizing electromagnetic energy, the gauge marks having a width greater than or equal to a frequency of the electromagnetic energy;
deforming the at least one test specimen; and
measuring a positional change between the one or more gauge marks.

6. The method for measuring deformations in test specimens according to claim 5, wherein the depth of the one or more gauge marks is less than a thickness of the coating material.

7. The method for measuring deformations in test specimens according to claim 5, wherein the depth of the one or more gauge marks is equal to a thickness of the coating material.

8. The method for measuring deformations in test specimens according to claim 5, wherein the depth of the one or more gauge marks is greater than a thickness of the coating material.

9. A method for measuring deformations in the specimens comprising:
marking at least one test specimen with one or more gauge marks utilizing electromagnetic energy, the gauge marks having a spacing equal to or greater than the frequency of the electromagnetic energy;
deforming the at least one test specimen; and
measuring a positional change between the one or more gauge marks.

10. A method for measuring deformations in the specimens comprising:
coating at least one test specimen with a coating material;
marking the at least one test specimen with one or more gauge marks utilizing electromagnetic energy, the gauge marks having a spacing equal to or greater than the frequency of the electromagnetic energy;
deforming the at least one test specimen; and
measuring a positional change between the one or more gauge marks.

11. A method for measuring deformations in test specimens comprising:
marking at least one test specimen with one or more gauge marks utilizing electromagnetic energy, the gauge markings having a depth of less than or equal to one half the grain size of the material comprising the test specimen;
deforming the at least one test specimen; and
measuring a positional change between the one or more gauge marks.

12. A method for measuring deformations in test specimens comprising:
coating at least one test specimen with a coating material;
marking the at least one test specimen with one or more gauge marks utilizing electromagnetic energy, the gauge markings having a depth of less than or equal to one half the grain size of the material comprising the test specimen;
deforming the at least one test specimen; and
measuring a positional change between the one or more gauge marks.

13. A system for marking test specimens comprising:
an indexing feature configured to hold and position one or more test specimens; and
an energy source positioned proximate the indexing fixture for producing gauge markings having a width greater than or equal to a frequency of the output of the energy source on the one or more test specimens.

14. A system for marking test specimens comprising:
an indexing feature configured to hold and position one or more test specimens; and
an energy source positioned proximate the indexing fixture for producing gauge markings having a spacing equal to or greater than a frequency of the output of the energy source on the one or more test specimens.

15. A system for marking test specimens comprising:
an indexing feature configured to hold and position one or more test specimens; and
an energy source positioned proximate the indexing fixture for producing gauge markings having a depth of less than or equal to one half the grain size of the material comprising the test specimen on the one or more test specimens.
